(19) United States
(12) Patent Application Publication
(10) Pub. No.: US 2007/0124678 A1
(43) Pub. Date: May 31, 2007

(54) Method and apparatus for identifying the high level structure of a program

(76) Inventors: Lalitha Agnihotri, Tarrytown, NY (US); Nevenka Kimitrova, Yorktown Heights, NY (US)

Correspondence Address: PHILIPS INTELLECTUAL PROPERTY & STANDARDS, P.O. BOX 3001, BRIARCLIFF MANOR, NY, 10510, US

(21) Appl. No.: 10/573,735

(22) PCT Filed: Sep. 28, 2004
(86) PCT No.: PCT/IB04/51902

§ 371 Date: Mar. 28, 2006

Related U.S. Application Data
(60) Provisional application No. 60/507,283, filed on Sep. 30, 2003.

(51) Int. Cl. H04N 7/173

(52) U.S. Cl. 715/720

(57) ABSTRACT

An apparatus and method are provided to recover the high level structure of a program, such as a television or video program using an unsupervised clustering algorithm in concert with a human analyst. The method is comprised of three phases, a first phase, referred to herein as a text type clustering phase, a second phase of genre/sub-genre identification phase in which the genre/sub-genre type of a target program is detected and a third and final phase, referred to herein as a structure recovery phase. The structure recovery phase relies on graphical models to represent program structure. The high level structure of a program, once recovered, may be advantageously used in a recover further information including, but not limited to, temporal events, text events, program events and the like.

The present invention relates generally to the field of video analysis, and more specifically to identifying the high level structure of a program, such as a television or video program using classifiers for the appearance of different types of video text appearing in the program.

As video becomes more pervasive, more efficient ways to analyze the content contained therein become increasingly necessary and important. Videos inherently contain a huge amount of data and complexity that makes analysis a difficult proposition. An important analysis is the understanding of the high-level structures of videos, which can provide the basis for further detailed analysis.

A number of analysis methods are known, see Yeung et al. “Video Browsing using Clustering and Scene Transitions on Compressed Sequences,” Multimedia Computing and Networking 1995, Vol. SPIE 2417, pp.399-413, February 1995, Yeung et al. “Time-constrained Clustering for Segmentation of Video into Story Units,” ICPR, Vol. C. pp. 375-380 August 1996, Zhong et al. “Clustering Methods for Video Browsing and Annotation,” SPIE Conference on Storage and Retrieval for Image and Video Databases, Vol. 2670, February 1996, Chen et al., “VIBE: A New Paradigm for Video Database Browsing and Search,” Proc. IEEE Workshop on Content-Based Access of Image and Video Databases, 1998, and Gong et al., “Automatic Parsing of TV Soccer Programs,” Proceedings of the International Conference on Multimedia Computing and systems (ICMCS), May 1995.

Gong et al. describes a system that used domain knowledge and domain specific models in parsing the structure of a soccer video. Like other prior art systems, a video is first segmented into shots. A shot is defined as all frames between a shutter opening and closing. Spatial features (playing field lines) extracted from frames within each shot are used to classify each shot into different categories, e.g., penalty area, midfield, corner area, corner kick, and shot at goal. Note that that work relies heavily on accurate segmentation of video into shots before features are extracted. Also shots are not quite representative of events that are happening in the soccer video.

Zhong et al. also described a system for analyzing sport videos. That system detects boundaries of high-level semantic units, e.g., pitching in baseball and serving in tennis. Each semantic unit is further analyzed to extract interesting events, e.g., number of strokes, type of plays—returns into the net or baseline returns in tennis. A color-based adaptive filtering method is applied to a key frame of each shot to detect specific views. Complex features, such as edges and moving objects, are used to verify and refine the detection results. Note that that work also relies heavily on accurate segmentation of the video into shots prior to feature extraction. In short, both Gong and Zhong consider the video to be a concatenation of basic units, where each unit is a shot. The resolution of the feature analysis does not go finer than the shot level. The work is very detailed and relies heavily on a color-based filtering to detect specific views. Furthermore, in the case where the color palette of the video changes, the system is rendered useless.

Thus, generally the prior art is as follows: first the video is segmented into shots.

Then, key frames are extracted from each shot, and grouped into scenes. A scene transition graph and hierarchy tree are used to represent these data structures. The problem with those approaches is the mismatch between the low-level shot information, and the high-level scene information. Those only work when interesting content changes correspond to the shot changes.

In many applications such as soccer videos, interesting events such as “plays” cannot be defined by shot changes. Each play may contain multiple shots that have similar color distributions. Transitions between plays are hard to find by a simple frame clustering based on just shot features.

In many situations, where there is substantial camera motion, shot detection processes tend to segment erroneously because this type of segmentation is from low-level features without considering the domain specific high-level syntax and content model of the video. Thus, it is difficult to bridge the gap between low-level features and high-level features based on shot-level segmentation. Moreover, too much information is lost during the shot segmentation process.

Videos in different domains have very different characteristics and structures. Domain knowledge can greatly facilitate the analysis process. For example, in sports videos, there are usually a fixed number of cameras, views, camera control rules, and a transition syntax imposed by the rules of the game, e.g., play-by-play in soccer, serve-by-serve in tennis, and inning-by-inning in baseball.

Tan et al. in “Rapid estimation of camera motion from compressed video with application to video annotation,” IEEE Trans. on Circuits and Systems for Video Technology, 1999, and Zhang et al. in “Automatic Parsing and Indexing of News Video,” Multimedia Systems, Vol.2, pp. 256-266, 1995, described video analysis for news and baseball. But very few systems consider high-level structure in more complex videos and a wide variety of videos.

For example for a soccer video the problem is that a soccer game has a relatively loose structure compared to other videos like news and baseball. Except the play-by-play structure, the content flow can be quite unpredictable and happen randomly. There is a lot of motion, and view changes in a video of a soccer game. Solving this problem is useful for automatic content filtering for soccer fans and professionals.

The problem is more interesting in the broader background of video structure analysis and content understanding. With respect to structure, the primary concern is the temporal sequence of high-level video states, for example, the game states play and break in a soccer game. It is desired to automatically parse a continuous video stream into an alternating sequence of these two game states.

Prior art structural analysis methods mostly focus on the detection of domain specific events. Parsing structures separately from event detection has the following advantages. Typically, no more than 60% of content corresponds to play. Thus, one could achieve significant information reduction by segmenting out portions of the video that correspond to break. Also, content characteristics in play and break are different, thus one could optimize event detectors with such prior state knowledge.

Related art structural analysis work pertains mostly to sports video analysis, including soccer and various other games, and general video segmentation. For soccer video, prior work has been on shot classification, see Gong above, scene reconstruction, Yow et al., “Analysis and Presentation of Soccer Highlights from Digital Video,” Proc. ACCV, 1995, December 1995, and rule-based semantic classification of Tovinkere et al., “Detecting Semantic Events in Soccer Games: Towards A Complete Solution,” Proc. ICME 2001, August 2001.

Hidden Markov models (HMM) have been used for general video classification and for distinguishing different types of programs, such as news, commercial, etc, see Huang et al., “Joint video scene segmentation and classification based on hidden Markov model,” Proc. ICME 2000, pp. 1551-1554 Vol.3, July 2000.

Heuristic rules based on domain specific features and dominant color ratios, have also been used to segment play and break, see Xu et al., “Algorithms and system for segmentation and structure analysis in soccer video,” Proc. ICME 2001, August 2001, and U.S. patent application Ser. No. 09/839,924 “Method and System for High-Level Structure Analysis and Event Detection in Domain Specific Videos,” filed by Xu et al. on Apr. 20, 2001. However, variations in these features are hard to quantify with explicit low-level decision rules.

Therefore, there is a need for a framework where all the information of low-level features of a video are retained, and the feature sequences are better represented. Then, it can become possible to incorporate a domain specific syntax and content models to identify high-level structure to enable video classification and segmentation at a high level program structure and not just shots.

A main idea of this invention is to discern the high level structure of a program, such as a television or video program using an unsupervised clustering algorithm in concert with a human analyst.

More particularly, the invention provides an apparatus and method for automatically determining the high level structure of a program, such as a television or video program. The inventive methodology is comprised of three phases, a first phase, referred to herein as a text type clustering phase, a second phase of genre/sub-genre identification phase in which the genre/sub-genre type of a target program is detected and a third and final phase, referred to herein as a structure recovery phase. The structure recovery phase relies on graphical models to represent program structure. The graphical models used for training can be manually constructed Petri nets, or automatically constructed Hidden Markov Models using Baum-Welch training algorithm. To uncover the structure of the target program, a Viterbi algorithm may be employed.

In the first phase (i.e., text type clustering), overlaid and superimposed text is detected from frames of a target program, such as a television or video program of interest to a user. For each line of text detected in the target program, various text features are extracted such as, for example, position (row, col), height, font type and color. A feature vector is formed from the extracted text features for each line of detected text. Next, the feature vectors are grouped into clusters based on an unsupervised clustering technique. The clusters are then labeled according to the type of text described by the feature vector (e.g., nameplate, scores, opening credits, etc.).

In the second phase (i.e., genre/sub-genre identification), a training process occurs whereby training videos representing various genre/sub-genre types are analyzed in accordance with the method described above at phase one to determine their respective cluster distributions. Once obtained, the cluster distributions serve as genre/sub-genre identifiers for the various genre/sub-genre types. For example, a comedy film will have a certain cluster distribution while a baseball game will have a distinctly different cluster distribution. Each, however, fairly represent their respective genre/sub-genre types. At the conclusion of the training process, the genre/sub-genre type for the target program may then be determined by comparing its cluster distribution, previously obtained at the first phase (text type clustering), with the cluster distributions for the various genre/sub-genre types obtained at the second phase.

In the third and final phase, (i.e., the high level program structure recovery phase), the high level structure of the target program is recovered by first creating a database of higher order graphical models whereby the models graphically represent the flow of videotext throughout the course of a program for a plurality of genre/sub-genre types. Once the graphical model database is constructed, using the results of text detection, determined at act 140, and the results of cluster distribution, determined at act 160, a single graphical model from amongst the plurality of stored models is identified and retrieved. The selected graphical model in concert with the text detection and cluster information are used to recover the high level structure of the program.

High level structure of a program, such as a video or television program, may be advantageously used in a wide variety of applications, including, but not limited to, searching for temporal events and/or text events and/or program events in a target program, as a recommender and for creating a multimedia summary of the target program.

The foregoing features of the present invention will become more readily apparent and may be understood by referring to the following detailed description of an illustrative embodiment of the present invention, taken in conjunction with the accompanying drawings, where

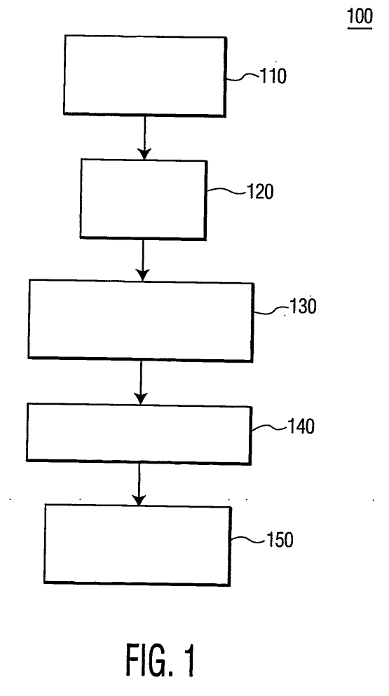

FIG. 1 is a flow diagram illustrating the text type clustering phase of the invention according to one embodiment;

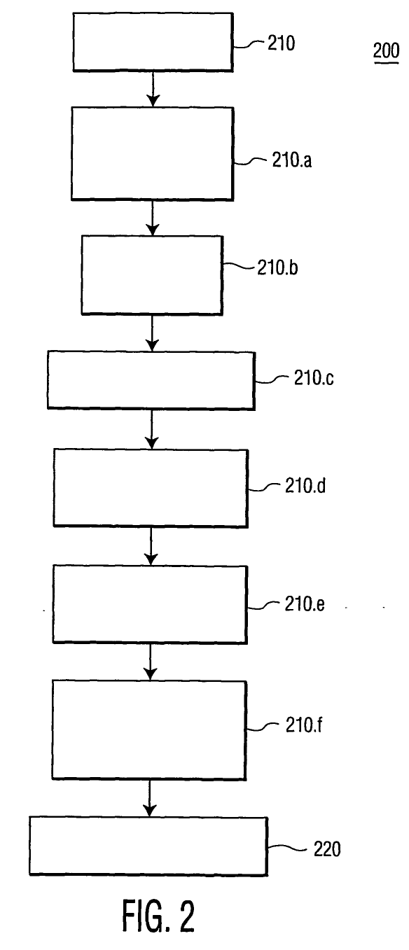

FIG. 2 is a flow diagram illustrating the genre/sub-genre identification phase of the invention according to one embodiment;

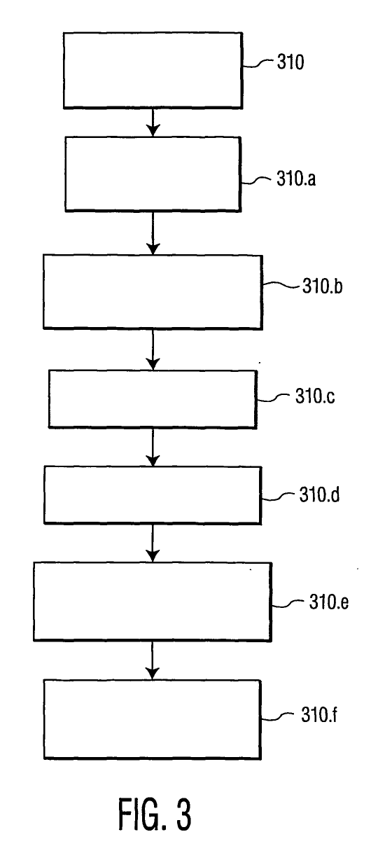

FIG. 3 is a flow diagram illustrating the high level structure recovery phase of the invention according to one embodiment;

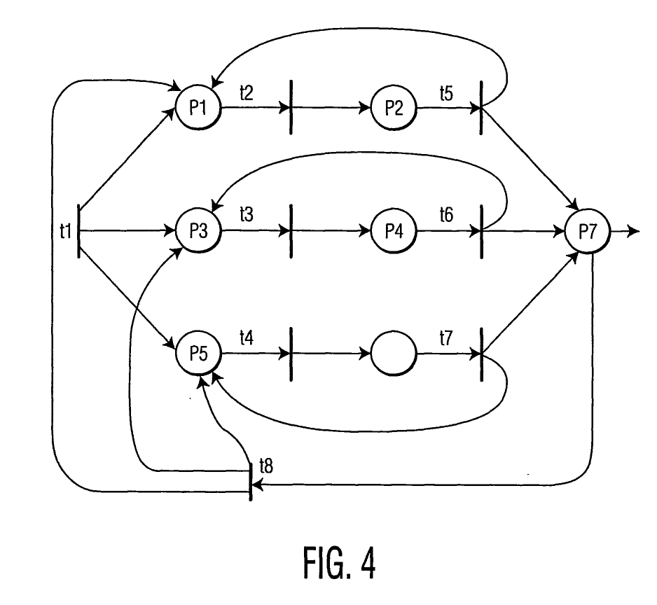

FIG. 4 is an exemplary graphical model which illustrates a program event of a movie;

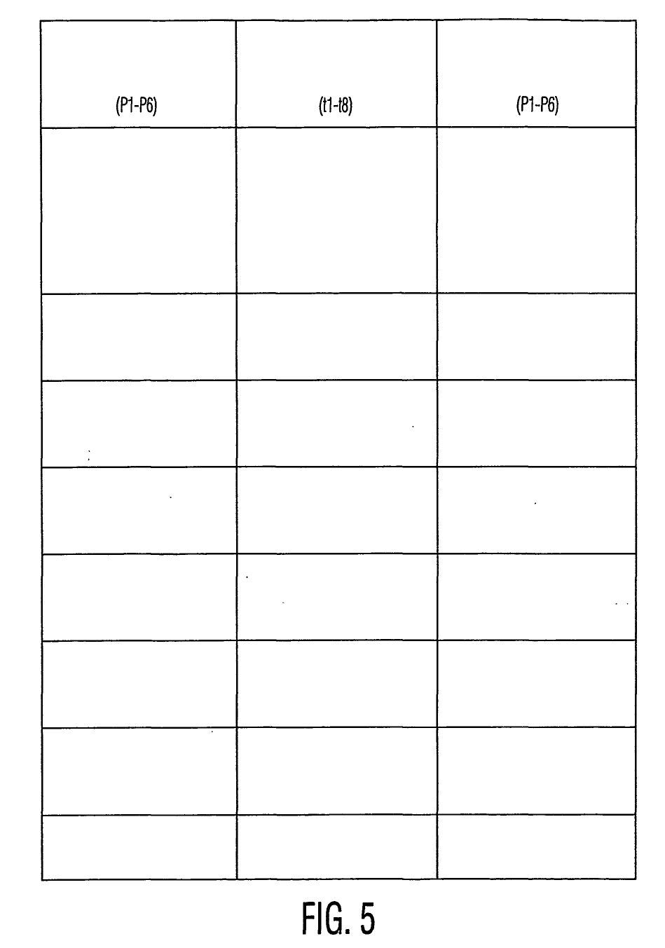

FIG. 5 is a summarization of the pre and post conditions associated with the graphical model of FIG. 4; and

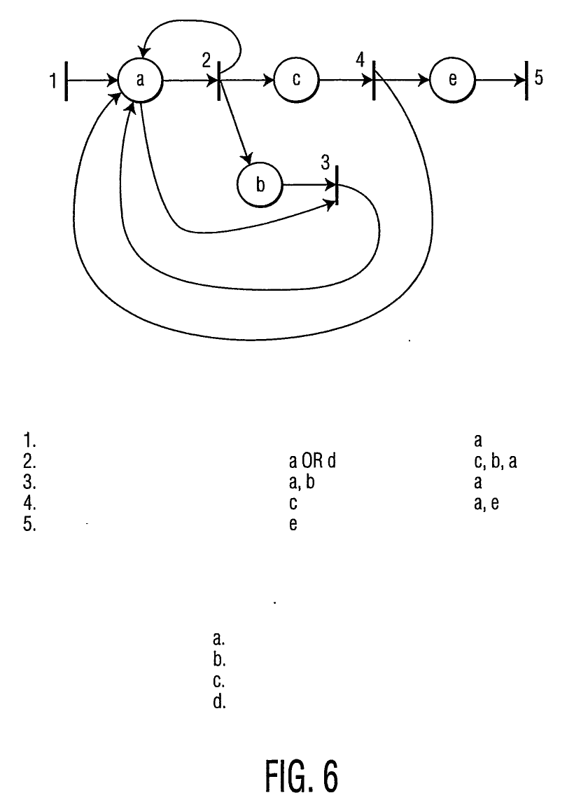

FIG. 6 is an illustrative example of a high order Petri net

In the following detailed description of the present invention, numerous specific details are set forth in order to provide a thorough invention may be practiced without these specific details. In some instances, well-known structures and devices are shown in block diagram form, rather than in detail, in order to avoid obscuring the present invention. Moreover, FIGS. 1-6, discussed below, and the various embodiments used to describe the principles of the present invention in this patent document are by way of illustration only and should not be construed in any way to limit the scope of the invention.

In the following description, a preferred embodiment of the present invention will be described in terms that would ordinarily be implemented as a software program. Those skilled in the art will readily recognize that the equivalent of such software may also be constructed in hardware. Because video processing algorithms and systems are well known, the present description will be directed in particular to algorithms and systems forming part of, or cooperating more directly with, the system and method in accordance with the present invention. Other aspects of such algorithms and systems, and hardware and/or software for producing and otherwise processing the video signals involved therewith, not specifically shown or described herein, may be selected from such systems, algorithms, components and elements known in the art. Given the system and method as described according to the invention in the following materials, software not specifically shown, suggested or described herein that is useful for implementation of the invention is conventional and within the ordinary skill in such arts.

Still further, as used herein, the computer program may be stored in a computer readable storage medium, which may comprise, for example; magnetic storage media such as a magnetic disk (such as a hard drive or a floppy disk) or magnetic tape; optical storage media such as an optical disc, optical tape, or machine readable bar code; solid state electronic storage devices such as random access memory (RAM), or read only memory (ROM); or any other physical device or medium employed to store a computer program.

The description which follows uses the terminology defined below:

Genre/Sub-genre—A genre is a kind, category, or sort, esp. of literary or artistic work and a sub-genre is a category within a particular genre. An example of a genre is “SPORT” with subgenres of Basketball, Baseball, Football, Tennis and so on. Another example of a genre is “MOVIE” with subgenres of Comedy, Tragedy, Musical, Action and so on. Other examples of genres include, for example, “NEWS”, “MUSIC SHOW”, “NATURE”, “TALK SHOW” and “CHILDRENS SHOW”.

Target Program—is a video or television program of interest to an end user. It is provided as an input to the process of the invention. Operating on the target program in accordance with the principles of the invention provides the following capabilities: (1) allowing an end user to receive a multimedia summary of the target program, (2) the recovery of the high level structure of the target program, (3) a determination of the genre/sub-genre of the target program, (4) the detection of predetermined content within the target program, which may be desired or undesired content in a program and (5) receiving information about the target program (i.e., as a recommender).

Clustering—Clustering divides the vector set so that vectors with similar content are in the same group, and groups are as different as possible from each other.

Clustering Algorithm—Clustering algorithms operate by finding groups of items that are similar and grouping them into categories. When the categories are unspecified, this is sometimes referred to as unsupervised clustering. When the categories are specified a priori, this is sometimes referred to as supervised clustering.

Turning now to FIGS. 1-3, the method of the invention according to one embodiment is shown.

FIG. 1 is a flowchart for illustrating the first phase of the invention according to one embodiment, referred to herein as the text-type clustering phase 100, in which overlaid and superimposed text is detected from frames of a target program, such as a television or video program of interest to a user.

FIG. 2 is a flowchart for illustrating the second phase of the invention according to one embodiment, referred to herein as genre/sub-genre identification, during which a training process occurs whereby training videos representing various genre/sub-genre types are analyzed to determine their respective cluster distributions. Once obtained, the cluster distributions serve as genre/sub-genre identifiers for the various genre/sub-genre types. At the conclusion of the training process, the genre/sub-genre type for the target program may then be determined by comparing its cluster distribution, with the cluster distributions for the various genre/sub-genre types obtained during training.

FIG. 3 is a flowchart for illustrating the third phase of the invention according to one embodiment, referred the target program structure recovery phase, during which the high level structure of the target program is determined by first creating a database of higher order graphical models whereby each model graphically represents the flow of videotext throughout the course of a program for a particular genre/sub-genre type. Once the database is constructed, previously obtained results at phase one of the process such as text detection and cluster distribution results pertaining to the target program are used to identify and select a single graphical model from among those stored in the database to recover the high level structure of the program.

Note that not all of the activities described in the process flow diagrams to be described below may be performed in addition to those illustrated. Also, some of the activities may be performed substantially simultaneously during with other activities. After reading this specification, skilled artisans will be capable of determining what activities can be used for their specific needs.

I. First Phase—Text Type Clustering

The first phase, i.e., the text-type clustering phase 100, as shown in the flowchart of FIG. 1, generally comprises the following acts:

110—detecting the presence of text in a “target program” of interest to an end user, such as a television or video program.

120—identifying and extracting text features for each line of video-text detected in the target program.

130—forming feature vectors from the identified and extracted features.

140—organizing the feature vectors into clusters.

150—labeling each cluster according to the type of video-text present in the cluster.

Each of these general acts will now be described in more detail.

At act 110, the process begins by analyzing the “target” television or video program to detect the presence of text contained within individual video frames of the target program. A more detailed explanation of video text detection is provided in U.S. Pat. No. 6,608,930 issued to Agnihotri et al. Aug. 19, 2003, entitled “Method and System for Analyzing Video Content Using Detected Text in Video Frames”, incorporated by reference herein in its entirety. The types of text that can be detected from the target program may include, for example, starting and ending credits, scores, title text nameplates and so on. Alternatively, text detection may also be accomplished in accordance with the MPEG-7 standard, which describes a method for static or moving video object segmentation.

At act 120, text features are identified and extracted from the detected text at act 110. Examples of text features may include position (row and column), height (h), font type (f) and color (r, g, b). Others are possible. For the position feature a video frame, for purposes of the invention, is considered to be divided into a 3×3 grid resulting in 9 specific regions. The row and column parameter of the position feature define the particular region where the text is located. For the font type (f) feature, “f” is indicative of the type of font used.

At act 130, for each line of detected text, the extracted text features are grouped into a single feature vector, Fᵥ.

At act 140, the feature vectors Fᵥ are organized (grouped) into clusters {C1, C2, C3, . . . }. Grouping is accomplished by using a distance metric between a feature vector F_{V1} and the clusters {C1, C2, C3, . . . }, F_{V2}, and associates the feature vector Fᵥ₁ with the cluster having the highest degree of similarity. An unsupervised clustering algorithm may be used to cluster the feature vectors Fᵥ based on the similarity measure.

In one embodiment, the distance metric used is a Manhattan distance which is computed as the sum of the absolute value of differences in the respective text features, computed as:
Dist(F_{V1},F_{V2})=w1*(F_{V1row}−F_{V2row}|+|F_{V1col}−F_{V2col}|)+w2*(|F_{V1b}−F_{V2b}|+w3*(|F_{V1f}−F_{V2f}|+|F_{V1g}−F_{V2g}|+|F_{V1b}−F_{V2b}|)+w4*(FontDist(f1, f2)) Eq. (1)
where: F_{V1row}, F_{V2row}=1^{st} and 2^{nd} and feature vector row positions;
F_{V1col}, F_{V2col}=1^{st} and 2^{nd} feature vector column positions;
F_{V1b}, F_{V2b}=1^{st} and 2^{nd} feature vector heights;
F_{V1f}, F_{V1g}, F_{V1b}=1^{st} feature vector color (r,g,b);
F_{V2f}, F_{V2g}, F_{V2b}=2^{nd} feature vector color (r,g,b);
f1=font type of first feature vector;
f2=font type of second feature vector;
FontDist (a,b)=A pre-computed distance between multiple font types;

It is noted that the weighting factors w1 through w4 as well as the “Dist” may be empirically determined.

At act 150, each cluster {C1, C2, C3, . . . } formed at act 140 is then labeled according to the type of text in the cluster. For example, cluster C1 may include feature vectors which describe text that is always broadcast in yellow and always positioned in the lower right hand portion of the screen. Accordingly, cluster C1 would be labeled “future program announcements” because the characteristics described refer to text that announces upcoming shows. As another example, cluster C2 may include feature vectors which describe text that is always broadcast in blue with a black banner around it and always positioned in the upper left hand portion of the screen. Accordingly, cluster C2 would be labeled “Sports scores” because the text characteristics are those used to always display the score.

The process of labeling clusters, i.e., act 150, may be performed manually or automatically. A benefit of the manual approach is that the cluster labels are more intuitive, e.g., “Title text”, “news update” etc. Automatic labeling produces labels such as “TextType1”, “Texttype2” and so on.

II. Second Phase—Genre/Sub-Genre Identification

The second phase, i.e., the genre/sub-genre identification phase 200, as shown in the flowchart of FIG. 2, generally comprises the following acts:

210—Performing genre/sub-genre identification training.
210.a—a number of training videos N, of a particular genre/sub-genre type are provided as input.
210.b—text detection is performed for each training video N.
210.c—text features are identified and extracted for each line of detected text in each training video N.
210.d—feature vectors are formed from the text features extracted at act 210.c.
210.e—cluster types {C1, C2, C3, . . . } are derived from the feature vectors
   by using a distance metric to associate the feature vectors formed at act 210.d with one of the cluster types {C1, C2, C3, . . } derived at act 140.
220—A genre feature vector is constructed for genre/sub-genre type of the target program.

To further aid in understanding how the genre feature vectors are used to define the various genre/sub-genre types, Table I is provided by way of example. The rows of table I depict the various genre/sub-genre types and the columns 2-5 depict the cluster distributions (counts) that result subsequent to performing genre/sub-genre identification, act 210.

TABLE I

| Genre/Sub-genre | C1 | C2 | C3 | C4 |
|---|---|---|---|---|
| Training sequence | count | count | Count | count |
| Movies/westerns | 13 | 44 | 8 | 43 |
| Sports/Baseball | 5 | 33 | 8 | 4 |
| Children/songs | 3 | 53 | 43 | 8 |
| Music/orchestra | 22 | 22 | 1 | 99 |
| News/International | 30 | 11 | 14 | 5 |
| Educational/Science | 7 | 34 | 3 | 15 |

The genre feature vectors determined from performing genre/sub-genre identification, characterize the respective genre/sub-genre types, e.g., Movies/westerns={13, 44, 8, 43}, Sports/Baseball {5, 33, 8, 4} and so on.

At act 220, the genre/sub-genre type for the target program is determined. The cluster distribution for the target program (previously computed at act 140), is now compared with the cluster distributions determined at act 210 for the various genre/sub-genre types. The genre/sub-genre type for the target program is determined by determining which cluster distribution, determined at act 210, is closest to the cluster distribution of the target program, determined at act 140. A threshold determination may be used to insure a sufficient degree of similarity. For example, it may be required that the target program's cluster distribution have a similarity score of at least 80% with the closest cluster distribution determined at act 210 to declare that a successful genre/sub-genre identification of the target program has been made.

Petri Nets Overview

Prior to describing the third phase 300, i.e., the high level structure recovery phase 300, as will be described below, as a foundation, a review is provided of some basic principles of graphical modeling with particular focus on Petri net theory.

The fundamentals of Petri Nets are well-known, and fairly presented in the book “Petri Net Theory and the Modeling of Systems”, by James L. Peterson of the University of Texas at Austin. This book is published by Prentice-Hall, Inc. of Englewood Cliffs, N.J., and is incorporated herein by reference.

Briefly, Petri nets are particular kinds of directed graphs consisting of two kinds of nodes, called places and transitions with directed arcs directed either from a place to a transition or from a transition to a place. Places are used to collect tokens, elements used to represent what is flowing through the system, and transitions move tokens between places.

An exemplary Petri net system with its places, transitions, arcs, and tokens is depicted in FIG. 4. The Petri net shown in FIG. 4 is a graphical model which models the introductory segment of the movie “The Player”. In the movie, beginning movie credits are shown in three separate text locations, referred to herein as L1, L2 and L3. The appearance and subsequent disappearance of text throughout the introductory segment at locations L1, L2 and L3 is graphically modeled by the Petri net in terms of system states and their changes. More particularly, the system state is modeled as one or more conditions and the system state changes are modeled as transitions, as will be described.

With continued reference to FIG. 4, the “places” of the exemplary Petri Net are represented by open circles and are labeled P1-P6 and represent in this instance “conditions”. For example, one condition of the Petri of FIG. 4 is “text appearing at movie screen location L1”. This condition is associated with place P5 for modeling purposes. The transitions are represented by rectangles and are labeled t1-t8 and represent events. For example, one event of the Petri net of FIG. 4 is “text starts at movie screen location L1”. This event is associated with t2 for modeling purposes.

The concept of conditions and events are but one interpretation of transitions and places as used in Petri Net theory. As shown, each transition t1-t8 has a certain number of input and output places representing the pre-conditions and post-conditions of the event, respectively. For an event to take place, the precondition must be satisfied.

A summarization of the pre and post conditions and the events which link them for the exemplary Petri net of FIG. 4 is provided in FIG. 5. The pre-conditions are described in column 1, the post-conditions are described in column 3 and the events that link the pre and post conditions are described at column 2.

The Petri net of FIG. 4 is but one example of the systematic flow of text, which describes a small segment of a television or video program. The Petri net of FIG. 4 can therefore be fairly characterized as a “lower-order” Petri net The present application utilizes “higher-order” Petri nets, which are constructed in part from “lower-order” Petri nets, as will be described below.

III. Third Phase—Recovery of the High Level Structure of the Target Program

The third phase, i.e., high level structure recovery phase 300, as shown in the flowchart of FIG. 3, generally comprises the following acts:

310—Objective: Recover the high level structure of the target program.
310.a—create a database of higher order graphical models.
310.b—identify hot spots within each of the higher order graphical models.
310.c—retrieve the results of text detection previously generated for the target program at act 140 (see FIG. 1).
310.d—retrieve the results of cluster distribution previously generated for the target program at act 160 (see FIG. 1).
310.e—using the results of cluster distribution for the target program, identify and retrieve a subset of high order graphical models from among the plurality of high order graphical models stored in the database.
310.f—using the results of text detection and the subset of high order graphical models identified at act 210.e, identify a single high order graphical model from among the subset of models identified at act 310.e that most closely resembles the sequence of text detection events for the target program, retrieved at act 210.c. The single high order graphical model graphically represents the high level structure of the target program.

Each of these general acts will now be described in more detail.

At act 310.a, a plurality of higher order graphical models (e.g., Petri nets) are constructed that describe the systematic flow of videotext throughout the course of an entire program. Each of the plurality of graphical models uniquely describe the flow of videotext for a particular genre/sub-genre type. The plurality of models are stored in a database for later reference in assisting in the determination of the genre/sub-genre type of the target program of interest to a user.

In one embodiment, the graphical models are manually constructed high order Petri nets. To construct such models by manual means, a system designer analyzes the videotext detection and cluster mapping throughout the course of a program for a variety of program genre/sub-genre types.

In another embodiment, the graphical models are automatically constructed as Hidden Markov Models using a Baum-Welch algorithm.

Irrespective of the method of construction, manual or automatic, some key characteristics of the high order graphical models are (1) the high order graphical models model the flow at a program level, and (2) the graphical models include transitions which are effectively short-hand representations of low order graphical models. In other words, the high order models are built in part from lower order graphical models. This key characteristic is further illustrated with reference to FIG. 6.

FIG. 6 is an illustrative example of a high order Petri net, which is one type of high order graphical model . The high order Petri net of FIG. 6 graphically illustrates the systematic flow of videotext throughout the course of a figure skating program. That is, it models systemic flow at a program level. As is well known, a figure skating program is made up of a number of program events, such as those listed in Table II below.

TABLE II

| EVENT | PRE-CONDITION | POST CONDITION |
|---|---|---|
| 1- Beginning credits | None | a |
| 2- Skater performance | a | c, b, a |
| 3- Interview with skater | a, b | a |
| 4- Overall standings | c | a, d |
| 5- Ending Credit | d | None |

The pre-conditions are required to trigger the events and the post conditions occur as a consequence of an event. The conditions in the present illustrative example may be defined as: (condition a—Program has started); (condition b—Skater introduced); (condition c—scores for skaters exist); and (condition d—final standings shown).

It is to be appreciated that the events 1-5 of the the high order net of FIG. 6 are really short-hand representations of low-order Petri nets. For example, the first event 1, i.e., beginning credits, is expandable as a low-order Petri net such as the one shown in FIG. 4.

At act 310.b—Within each high order graphical model, constructed at act 210.a, a number of regions of interest (“hot spots”) may be identified. These hot spots may be of varying scope. These hot spot regions correspond to those events which may be of particular interest to an end user. For example, event 2, “skater performance”, may have more significance as a program event of interest than event 1, beginning credits. The so-called “hot-spots” may be assigned a rank order corresponding to its relative importance. Furthermore, the low order Petri nets which make up the high order Petri nets may also be identified for the so-called hot spots.

At act 310.c—retrieve the results of text detection previously generated for the target program at act 140 (see FIG. 1).

At act 310.d—retrieve the results of cluster distribution previously generated for the target program at act 160 (see FIG. 1).

At act 310.e—using the cluster distribution data for the target program, previously retrieved at act 210.d, a subset of the high order graphical models created at act 210.a are identified and selected from the database. The subset of high order models are selected by determining which high order models contain the same clusters identified for the target program.

At act 310.f—using the text detection data for the target program, previously retrieved at act 310.c, a single high order Petri net from among the subset of nets identified at act 310.d is identified. To identify one high order Petri net, the text detection data is compared with the systemic flow of each Petri net of the subset of Petri nets to identify the one Petri net that satisfies the sequence of text events for the target program.

As a result of identifying the single graphical model that most closely resembles the high level structure of the target program, information about the target program may be easily obtained. Such information may include, for example, temporal events, text events, program events, program structure, summarization.

As one specific example, program event information can be discerned using the text detection data from the target program together with single identified high order graphical model. Table III represents fictitious text detection data for a target program.

As illustrated in the first row of Table III, text detection yields data pertaining to the cluster type of the particular text event detected (col. 1), the time at which the text event occurred (col. 2), the duration of the text event (col. 3) and time boundary information specifying lower and upper time limits within which the text event must occur. It is to be appreciated that the table represents a significantly reduced version of the sequence of text events that occur throughout the duration of a program, for ease of explanation.

TABLE III

| TEXT EVENT | EVENT | | | | |
|---|---|---|---|---|---|
| STREAM FOR THE | OCCURS AT | | | | TIME BOUNDARY BETWEEN |
| TARGET PROGRAM | TIME | | DURATION OF EVENT | | PRE AND POST EVENT |
| Text of cluster | 10 | SEC. | 20 | second duration | |
| type 1 | | | | | |
| Text of cluster | 35 | SEC. | 10564 | second duration | Occurs after a minimum of 3 seconds of |
| type 2 | | | | | text of cluster type 1 and no longer than 10 |
| | | | | | seconds later. After the occurrence of text. |
| Text of cluster | 57 | SEC. | 102 | second duration | Occurs after a minimum of 20 seconds of |
| type 2 | | | | | text of cluster type 1 and no longer |
| | | | | | than 30 seconds later. |
| Text of cluster | 896 | SEC. | 20 | second duration | Occurs after a minimum of 23 seconds of |
| type 4 | | | | | text of cluster type 11 and no longer than |
| | | | | | 170 seconds later. |
| Text of cluster | 1900 | SEC. | 5000 | second duration | Occurs after a minimum of 10 seconds of |
| type 3 | | | | | text of cluster type 2 and no longer than 25 |
| | | | | | seconds later. |
| Text of cluster | 3500 | SEC. | 800 | second duration | Occurs after a minimum of 334 seconds of |
| type 5 | | | | | text of cluster type 7 and no longer than 15 |
| | | | | | later |
| Text of cluster | 25,010 | SEC. | 800 | second duration | Occurs after a minimum of 334 seconds of |
| type 12 | | | | | text of cluster type 7 and no longer than 15 |
| | | | | | seconds later |

It is to be appreciated that certain information about the target program can be directly extracted from the text detection data, as illustrated in Table III. Such information includes, for example, the number of occurrences of particular text cluster types, the duration and/or time of occurrence of particular text cluster types and so on. A person skilled in the art can envision other combinations of data extractable from the text detection data Further, when the text detection data is combined with the identified high order graphical model which best represents the structure of the target program, additional information about the target program may be derived such as, program events and program structure. For example, with reference to Table III, the first three rows describe the occurrence of text cluster types in the following order: text cluster type 1, followed by text cluster type 1 again, followed by text cluster type 2. This sequence, or any other sequence from the table, may be used in conjunction with the high level graphical model to determine whether the sequence {1,2,2} constitutes a program event in the graphical model. If so, the program event may, in certain applications, be extracted for inclusion in a multimedia summary. The determination as to whether any selected sequence, e.g., {1,2,2} constitutes a program event is based on whether the sequence occurs within the time boundaries specified in the fourth column of the table. This time boundary information is compared against the time boundaries which are built in as part of the higher order graphical model. One example of this are timed Petri nets.

It is to be understood that the embodiments and variations shown and described herein are merely illustrative of the principles of this invention and that various modifications may be implemented by those skilled in the art without departing from the scope and spirit of the invention.

In interpreting the appended claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function; and

e) each of the disclosed elements may be comprised of hardware portions (e.g., discrete electronic circuitry), software portions (e.g., computer programming), or any combination thereof.

1. A method for recovering a high level structure of a target program, comprising the acts of:
a) generating text detection data for the target program;
b) generating a genre/sub-genre feature vector for the target program using the text detection data generated at act (a);
c) creating a plurality of high order graphical models;
d) identifying a subset of said high order graphical models using said target program cluster distribution data; and
d) identifying a single high order graphical model from said subset of models using said target program text detection data,
wherein said single high order graphical model corresponds to the high level structure of the target program.

2. The method of claim 1, further comprising the act of creating a program summary using said single high order graphical model with said text detection data.

3. The method of claim 2, wherein said act of creating said program summary further comprises the acts of:
determining one or more events of importance to a viewer;
searching said text detection data for said important events;
extracting said important events from said text detection data; and
including said extracted events in said program summary.

4. The method of claim 1, further comprising the act of creating a program summary, comprising the acts of:
searching for a program event;
ranking the program events identified at said searching act based on a pre-determined ranking;
selecting certain of said identified program events based on said ranking.

5. The method of claim 4, wherein the act of searching for a program event comprises the acts of:
determining a sequence of text events that collectively define a program event;
searching said text detection data for said sequence of text events;
upon identifying said sequence of text events in said text detection data, comparing said sequence of text events with corresponding nodes in said high order graphical model; and
determining if the time sequence of occurrence of said sequence of text events conforms with time constraints associated with said corresponding nodes in said high order graphical model.

6. The method of claim 1, further comprising the act of searching for information in said target program comprising: text types, similarities with programs other than said target program, text patterns, program events and patterns of program events.

7. The method of claim 6, wherein said information to be searched in said target program uses information provided by said text detection data and said single high order graphical model.

8. The method of claim 1, wherein said graphical model is one of a Petri net model, a Hidden Markov Model and a combination of said Petri net model and said Hidden Markov Model.

9. The method of claim 1, wherein the target program is one of a television and video program.

10. The method of claim 1, wherein the act of generating text detection data for the target program further comprises the acts of:
i) detecting the presence of text in the target program;
ii) identifying and extracting text features of the detected text; and
iii) forming text feature vectors from the identified and extracted features.

11. The method of claim 10, wherein the act of detecting the presence of text in the target program is performed in accordance with the MPEG-7 standard.

12. The method of claim 10, wherein said identified and extracted text features comprise text position, text height, text font type, and text color.

13. The method of claim 10, wherein the act of detecting the presence of text in the target program further comprises the act of detecting the presence of text in particular video frames of the target program.

14. The method of claim 10, wherein the act of generating said genre/sub-genre feature vector for the target program further comprises the acts of:
comparing the text feature vectors for the target program generated at act (iii) with a plurality of pre-determined genre/sub-genre feature vectors for various genre/sub-genre types; and
associating the text feature vectors for the target program with the genre/sub-genre feature vectors having the highest degree of similarity;
defining the collection of genre/sub-genre feature vectors identified at the associating step as the genre/sub-genre feature vector for the target program.

15. The method of claim 1, wherein said plurality of high order graphical models graphically model particular program genre/sub-genre types at a program level.

16. The method of claim 12, wherein a transition element of said high order graphical model may be comprised of a low order graphical model, said low order model including program text and timing information.

17. The method of claim 16, wherein said low order graphical model is modeled as a Petri net.

18. The method of claim 17, wherein said transition element may be assigned a priority rank order relative to other transition elements of said high order model.

19. The method of claim 1, wherein the act of generating genre feature vector clusters data for the target program is performed in accordance with an unsupervised clustering algorithm.

20. The method of claim 19, wherein the unsupervised clustering algorithm is based on a distance metric comparing corresponding text features.

21. The method of claim 20, wherein the distance metric is computed as:
Dist(F_{V1},F_{V2})=w1*(|F_{V1row}−F_{V2row}|+|F_{V1col}−F_{V2col}|)+w2(|F_{V1b}−F_{V2b}|+w3*(|F_{V1f}−F_{V2f}|+|F_{V1g}−F_{V2g}|+|F_{V1b}−F_{V2b}|)+w4*(FontDist(f1, f2))
where: F_{V1row}, F_{V2row}=1^{st} and 2^{nd} feature vector row positions;
F_{V1col}, F_{V2col}=1^{st} and 2^{nd} feature vector column positions;
F_{V1h}, F_{V2h}=1^{st} and 2^{nd} feature vector heights;
F_{V1r}, F_{V1g}, F_{V1b}=1^{st} feature vector color (r,g,b);
F_{V2r}, F_{V2g}, F_{V2b}=2^{nd} feature vector color (r,g,b);
f1=font type of first feature vector;
f2=font type of second feature vector; and
FontDist(a,b)=A precomputed distance between multiple font types.

22. A system for recovering the high-level structure of a target program, said system comprising: a memory for storing computer readable code, a database for storing a plurality of higher-order Petri nets and a processor operatively coupled to said memory, said processor configured to generate text detection data for the target program; generate a genre/sub-genre feature vector for the target program using the text detection data; create a plurality of high order graphical models; identify a subset of said high order graphical models using said target program cluster distribution data; and identify a single high order graphical model from said subset of models using said target program text detection data, wherein said single high order graphical model corresponds to the high level structure of the target program.
